(19) United States
(12) Patent Application Publication
(10) Pub. No.: US 2025/0175913 A1
(43) Pub. Date: May 29, 2025

(54) FAST ONBOARDING IN A WIRELESS COMMUNICATION DEVICE SYSTEM

(71) Applicant: QUALCOMM Incorporated, San Diego, CA (US)

(72) Inventors: Robin ., Noida (IN); Nicolas GRAUBE, Cambridge (GB); Rahul SANGWAN, Charkhi Dadri (IN); Sonu LNU, Faridabad (IN); Deep Shikha AGGARWAL, Gurugram (IN); Randhir KUMAR, New Delhi (IN)

(21) Appl. No.: 18/523,140

(22) Filed: Nov. 29, 2023

(51) Int. Cl. H04W 56/00; H04W 48/08; H04W 76/10

(52) U.S. Cl. CPC H04W 56/001; H04W 48/08; H04W 76/10

(57) ABSTRACT

Systems and techniques are described for wireless communications. For example, a computing device can transmit, to a plurality of wireless communication devices, a message comprising a plurality of available channel subframes. The computing device can receive, on one or more available channel subframes of the plurality of available channel subframes from one or more wireless communication devices of the plurality of wireless communication devices, an initiation request message requesting synchronization with the network device. The computing device can transmit, on the one or more available channel subframes to the one or more wireless communication devices, an initiation response message confirming the synchronization with the network device. The computing device can establish a synchronized connection with the one or more wireless communication devices on the one or more available channel subframes.

### FIELD

The present disclosure generally relates to wireless communications. For example, aspects of the present disclosure relate to fast onboarding in a wireless communication device system, such as an access point-electronic shelf label (AP-ESL) system.

### BACKGROUND

Short range wireless communication enables wireless communication over relatively short distances (e.g., within thirty meters). For example, BLUETOOTH® is a wireless technology standard for exchanging data over short distances using short-wavelength ultra-high frequency (UHF) radio waves from 2.4 gigahertz (GHz) to 2.485 GHz.

BLUETOOTH® Low Energy (BLE) is a form of BLUETOOTH® communication that allows for communication with devices running on low power. Such devices may include beacons, which are wireless communication devices that may use low-energy communication technology for positioning, proximity marketing, or other purposes. In some cases, such devices may serve as nodes (e.g., relay nodes) of a wireless mesh network that communicates and/or relays information to a managing platform or hub associated with the wireless mesh network.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems and techniques for performing fast onboarding in a wireless communication device system, such as an AP-ESL system. According to at least one example, a network device is provided for wireless communications. The network device includes at least one memory and at least one processor coupled to the at least one memory and configured to: output, for transmission to a plurality of wireless communication devices, a message including a plurality of available channel subframes; receive, on one or more available channel subframes of the plurality of available channel subframes from one or more wireless communication devices of the plurality of wireless communication devices, an initiation request message requesting synchronization with the network device; output, for transmission on the one or more available channel subframes to the one or more wireless communication devices, an initiation response message confirming the synchronization with the network device; and establish a synchronized connection with the one or more wireless communication devices on the one or more available channel subframes.

In another illustrative example, a method is provided for wireless communication performed at a network device. The method includes: transmitting, by the network device to a plurality of wireless communication devices, a message including a plurality of available channel subframes; receiving, by the network device on one or more available channel subframes of the plurality of available channel subframes from one or more wireless communication devices of the plurality of wireless communication devices, an initiation request message requesting synchronization with the network device; transmitting, by the network device on the one or more available channel subframes to the one or more wireless communication devices, an initiation response message confirming the synchronization with the network device; and establishing, by the network device, a synchronized connection with the one or more wireless communication devices on the one or more available channel subframes.

In another illustrative example, a non-transitory computer-readable medium is provided having stored thereon instructions that, when executed by one or more processors, cause the one or more processors to: output, for transmission to a plurality of wireless communication devices, a message including a plurality of available channel subframes; receive, on one or more available channel subframes of the plurality of available channel subframes from one or more wireless communication devices of the plurality of wireless communication devices, an initiation request message requesting synchronization with the network device; output, for transmission on the one or more available channel subframes to the one or more wireless communication devices, an initiation response message confirming the synchronization with the network device; and establish a synchronized connection with the one or more wireless communication devices on the one or more available channel subframes.

In another illustrative example, an apparatus is provided for wireless communication. The apparatus includes: means for transmitting, to a plurality of wireless communication devices, a message including a plurality of available channel subframes; means for receiving, on one or more available channel subframes of the plurality of available channel subframes from one or more wireless communication devices of the plurality of wireless communication devices, an initiation request message requesting synchronization with the network device; means for transmitting, on the one or more available channel subframes to the one or more wireless communication devices, an initiation response message confirming the synchronization with the network device; and means for establishing a synchronized connection with the one or more wireless communication devices on the one or more available channel subframes.

Aspects generally include a method, apparatus, system, computer program product, non-transitory computer-readable medium, user device, user equipment, wireless communication device, and/or processing system as substantially described with reference to and as illustrated by the drawings and specification.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

Illustrative aspects of the present application are described in detail below with reference to the following figures:

FIG. 1 is a diagram illustrating an example environment in which systems and/or methods described herein may be implemented, in accordance with some aspects of the present disclosure.

FIG. 2 is a diagram illustrating example components of a device, in accordance with some aspects of the present disclosure.

FIG. 3 is a signaling diagram illustrating example communication transmissions, in accordance with some aspects of the present disclosure.

FIG. 4 is a signaling diagram illustrating an example of communication transmissions between a network device and two groups of wireless communication devices, in accordance with some aspects of the present disclosure.

FIG. 5 is a signaling diagram illustrating an example of communication transmissions between a network device and wireless communication devices using legacy channels for onboarding of the wireless communication devices to the network device, in accordance with some aspects of the present disclosure.

FIG. 6 is a signaling diagram illustrating an example of communication transmissions between a network device and wireless communication devices using legacy channels and extended channels for onboarding of the wireless communication devices to the network device, in accordance with some aspects of the present disclosure.

FIG. 7 is a flow diagram illustrating an example of a process for fast onboarding in a wireless communication device system, in accordance with some aspects of the present disclosure.

FIG. 8 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

A system may include one or more wireless communication devices that are controlled by a network entity. For example, a system including multiple peripheral devices (e.g., an electronic shelf label (ESL) system) may include one or more wireless communication devices (e.g., peripheral devices, such as ESLs) that are controlled by a network entity, such as a management entity (ME), via at least one additional network entity, such as an access point (AP). As used herein, the terms “network entity” and “network device” may be interchangeable. For example, an AP can be referred to as an example of a “network entity” and/or can be referred to as an example of a “network device.” A “network entity” can include an AP, an ME, and/or a combination of the two. A “network device” can include an AP, an ME, and/or a combination of the two. In some examples, a single device can implement the functionality of an ME and an AP (e.g., an ME and an AP can be combined in a single device).

In one or more examples, to facilitate control by the ME, each peripheral device (e.g., ESL) may have a wireless connection (e.g., a BLUETOOTH® Low Energy (BLE) connection or other connection) to AP that is communicatively connected to the ME (e.g., via the Internet, such as wirelessly, via an Ethernet connection, etc.). In some cases, commands from the ME may be wirelessly transmitted to the peripheral devices (e.g., ESLs) by the AP. Responses or information from the peripheral devices may also be received by the AP and provided by the AP to the ME.

Each AP may have an associated channel map. A channel map is a listing of frequency channels to be utilized or, conversely, not to be utilized (e.g., in the context of modification of frequency hopping sequences) by an AP for communication, such as with the ESLs or other peripheral devices. While examples are described herein using ESLs as illustrative examples of wireless communication devices, a management entity as an example of a network entity, and access points as examples of network entities, the systems and techniques described herein are applicable to any type of system or network.

In ESL systems, periodic Advertisements (PAs) can be utilized to provide regular and predictable payload transmissions from a central device (e.g., which may be in the form of a network device, such as an AP) to one or more peripheral devices (e.g., which may each be in the form of a wireless communication device, such as an ESL or other peripheral device). For example, PAs can be used to issue information from a central device to multiple peripheral devices, which may be within one or more groups of peripheral devices. PAs are generally unidirectional (e.g., unidirectional transmissions) such that PAs are transmitted only one-way from a central device to one or more peripheral devices.

Periodic Advertisement with Response (PAwR) can be used for ESL systems to provide bidirectionality (e.g., bidirectional transmissions between a central device and one or more peripheral devices). Peripheral devices synchronized within a group of peripheral devices can be addressed by a central device on a synchronized channel (e.g., a radio frequency (RF) channel between the central device and the peripheral devices) whenever the central device determines to send (e.g., transmit) a request to the peripheral devices. In some cases, as used herein, a synchronized channel refers to a channel on which transmissions are synchronized (in time). For example, the channel can utilize or can be based on a frequency on which one or more communications are transmitted. A hopping frequency sequence (HFS) can be associated with the channel. In some cases, the HFS may progress at a fixed and/or pre-determined interval. In some cases, a channel map may change, such as if interference on one or more channels changes, in which case the HFS can be updated (there may not be a fixed interval). In such cases, a minimum time between updates of a HFS can be applied, which can avoid updating the HFS too frequently. A central device and one or more peripheral devices can concurrently track the sequence at a predefined frequency hopping pattern or sequence (e.g., so the central device knows when to transmit the request and the peripheral devices know when to listen for and/or receive the request).

A request transmitted by a central device to peripheral devices in a particular group may be a PA containing a synchronization message transmitted by the central device on the synchronized channel to the peripheral devices of the particular group. For example, wireless communication devices within the particular group can wake up (e.g., from a low power (LP) mode) at the same PA transmission with respect to a particular PAwR train for that group. A PA is made up of a periodic set of transmissions, where the collection of transmissions is collectively referred to as a PA train or a PAwR train when applied to PAwR. Each transmission of a PA train (or PAwR train) occurs at a precise point in time, with fixed intervals between the transmissions. A communication channel (e.g., one communication channel out of thirty-seven available communication channels) is selected for each of the transmissions, where the communication channel follows a hopping frequency sequence. The synchronization between the central device and the peripheral devices in the group is based on the periodicity of the PA. The periodically-transmitted messages (e.g., the synchronization messages) include zero, one, or more commands (e.g., a respective operational code (OpCode) and parameters associated with each command). If a response from a peripheral device is expected by the central device (e.g., the synchronization message from the central device requests a response from a specific peripheral device), the particular peripheral device will respond in a specific response slot, based on where the peripheral device appeared within a sequence contained within the synchronization message transmitted by the central device.

Each access point may have an associated channel map. A channel map is a listing of frequency channels to be utilized or, conversely, not to be utilized (e.g., in the context of modification of frequency hopping sequences) by an access point for communication, such as with the ESLs or other devices. For example, for a particular PA train, PA packets can be transmitted on a particular number of channels (e.g., 37 data channels). The channels that are used and the channels that are not used can be indicated by the channel map. The channel map of an access point can be updated via a channel map update (CMU). A CMU is a procedure for updating (or changing) a current channel map (ChM) for an access point to a new channel map for the access point. As noted previously, the access point can send a synchronization message as a PA to the ESLs. The synchronization message can include various types of information, including information associated with a CMU in addition to other information. For example, when an access point is performing a CMU, information associated with the CMU can be included in one or more fields (e.g., an Additional Controller Advertising Data (ACAD) field) of a synchronization message. The CMU information included in a synchronization message can notify one or more ESLs of the new channel map to be used for future communications with the access point.

In some cases, an ESL may be physically moved to a new location. For example, the ESL may be moved from one location in a retail store (e.g., a particular shelf or a storage area) to a different location. Changing the location of the ESL may result in the ESL losing synchronization with (e.g., due to being out of communications range) a current access point for which the ESL is associated. Such a loss in synchronization may interrupt the management entity's ability to control the ESL and the ESL's ability to report to the management entity. After determining a network outage (e.g., caused by the loss of synchronization), the ESL may perform an onboarding procedure to reestablish synchronization with an access point.

In some cases, PAwR allows BLE peripheral devices (e.g., ESLs) to perform an onboarding procedure to synchronize with a central device (e.g., an access point) and, as such, be able to respond to periodic transmissions from the central device. For example, for an onboarding procedure in a retail setup (e.g., within a retail store or warehouse environment), an access point can act as a central device, and ESLs can act as peripheral devices. When the ESLs are powered, the ESLs can scan to receive a wake up packet (WUP) from the access point. The WUP can contain advertisement parameters for the ESLs. Upon receiving the WUP from the access point, the ESLs can transmit advertisement messages (e.g., a connectable advertisement (CAP)) on a legacy channel based on parameters (e.g., interval and duration parameters) received within the WUP. The legacy channel may include Bluetooth channels 37, 38, or 39 in some cases.

The access point can scan to receive the CAPs from the ESLs, and then create a generic attribute profile (GATT) connection with one of the advertising ESLs to perform onboarding of that ESL. The onboarding process involves the transfer of periodic advertisement synchronization transfer (PAST) information, where an access point can share its PAwR timing with the ESL. When multiple access points receive a CAP from an ESL, the access points can report the received CAP to the management entity. The management entity can then shortlist one of the access points to onboard the ESL.

The GATT connection process with one of the advertising ESLs to perform onboarding of that ESL has a high dependency on the legacy frequency spectrum (e.g., legacy channels), and takes a longer duration of time to complete as compared to a GATT connection with already synchronized ESLs.

For this onboarding process, the ESLs are transmitting CAPs over the legacy channels until the onboarding process is completed. In an environment where multiple ESLs are onboarded together onto an access point, the onboarding procedure can consume significant computing resources (e.g., processor resources, memory resources, and/or battery resources, among other examples) of the ESLs and/or the access point, and the frequent advertisements (e.g., CAPs) by the ESLs can result in spectral pollution on the legacy channels of the wireless network, packet collisions until the onboarding procedure completes, and an increased onboarding time.

In one or more aspects of the present disclosure, systems, apparatuses, methods (also referred to as processes), and computer-readable media (collectively referred to herein as “systems and techniques”) are described herein that provide solutions for fast onboarding in a wireless communication device system, such as an AP-ESL system. In one or more examples, the systems and techniques utilize a modal transition in an access point mode to reduce the dependency on the legacy channels (e.g., Bluetooth channels 37, 38, and 39) for onboarding of ESLs. In some examples, the systems and techniques indicate usage of a response slot for an ESL to communicate with an access point regarding the onboarding of the ESL to that access point. In one or more examples, the systems and techniques can allow for a dynamic capability to distribute the ESLs across groups using auxiliary advertisements. In some examples, an access point can use a synchronized channel for creating a connection with an ESL for onboarding that ESL. In one or more examples, the systems and techniques allow for less congestion on the legacy channels until the onboarding is completed, a faster onboarding, and a reduced number of CAP transmissions, which can result in reduced power consumption by the ESLs.

Additional aspects of the present disclosure are described in more detail below.

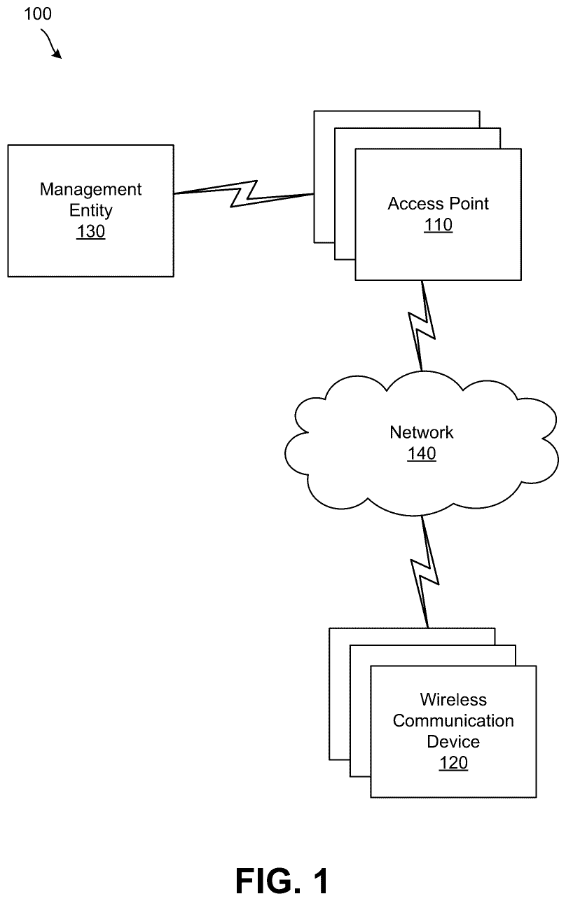

FIG. 1 is a diagram of an example environment 100 in which systems and/or methods described herein may be implemented. As shown in FIG. 1, the environment 100 may include at least one access point (AP) 110, at least one wireless communication device 120, a management entity (ME) 130, and a network 140. Devices of the environment 100 may interconnect via wired connections, wireless connections, or a combination of wired and wireless connections.

The access point 110 may include one or more devices capable of receiving, generating, storing, processing, providing, and/or routing information associated with access point synchronization and/or handover, as described elsewhere herein. The access point 110 may include a communication device and/or a computing device. The access point 110 may be configured to transmit beacons (e.g., BLE beacons), as well as to scan and locate other devices (e.g., other devices communicating using BLE protocols).

The wireless communication device 120 may include one or more devices capable of receiving, generating, storing, processing, and/or providing information associated with access point synchronization and/or handover, as described elsewhere herein. The wireless communication device 120 may include a communication device and/or a computing device. In some aspects, the wireless communication device 120 may be, may include, or may be included in an electronic shelf label (ESL).

The management entity 130 includes one or more devices capable of receiving, generating, storing, processing, providing, and/or routing information associated with access point synchronization and/or handover, as described elsewhere herein. The management entity 130 may include a communication device and/or a computing device. For example, the management entity 130 may include a server, such as an application server, a client server, a web server, a database server, a host server, a proxy server, a virtual server (e.g., executing on computing hardware), or a server in a cloud computing system. In some aspects, the management entity 130 includes computing hardware used in a cloud computing environment. The management entity 130 may provide control of a system (e.g., an ESL system) that includes the access point(s) 110, the wireless communication device(s) 120, and/or other device(s). The access point(s) 110 may be communicatively connected to the management entity 130 via a network (not shown), such as the Internet.

The network 140 may include one or more wireless networks. For example, the network 140 may include a personal area network (e.g., a Bluetooth network). The network 140 enables communication among the devices of environment 100.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

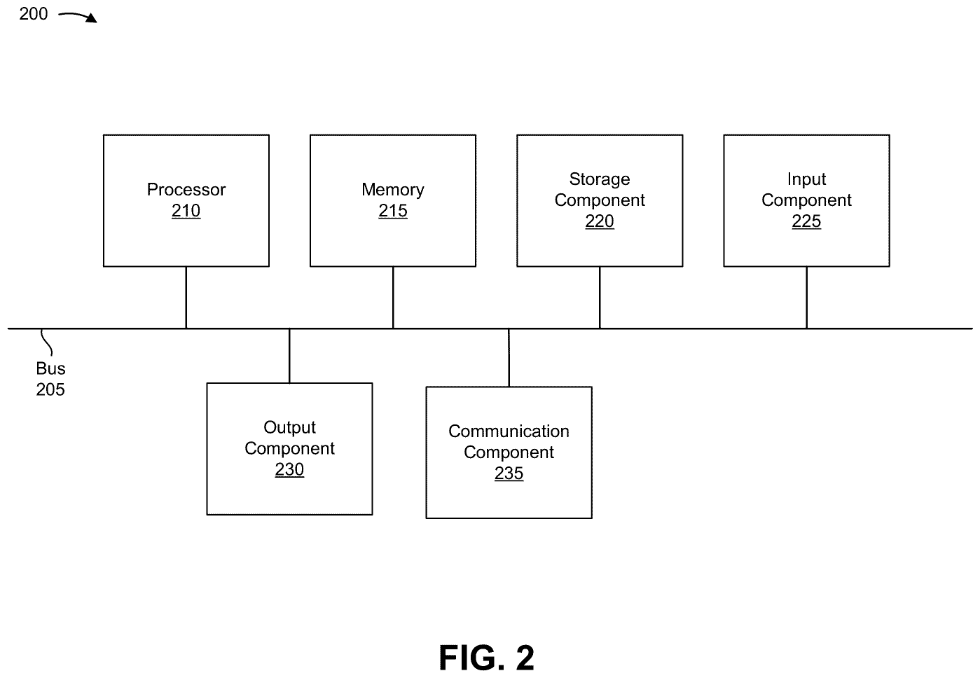

FIG. 2 is a diagram illustrating example components of a device 200, in accordance with the present disclosure. Device 200 may correspond to access point 110, wireless communication device 120, and/or management entity 130. In some aspects, access point 110, wireless communication device 120, and/or management entity 130 may include one or more devices 200 and/or one or more components of device 200. As shown in FIG. 2, device 200 may include a bus 205, a processor 210, a memory 215, a storage component 220, an input component 225, an output component 230, and/or a communication component 235.

Bus 205 may include a component that permits communication among the components of device 200. Processor 210 may be implemented in hardware, firmware, or a combination of hardware and software. Processor 210 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 210 may include one or more processors capable of being programmed to perform a function. Memory 215 may include a random access memory (RAM), a read only memory (ROM), and/or another type of dynamic or static storage device (e.g., a flash memory, a magnetic memory, and/or an optical memory) that stores information and/or instructions for use by processor 210.

Storage component 220 can store information and/or software related to the operation and use of device 200. For example, storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 may include a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., a global positioning system (GPS) component or a global navigation satellite system (GNSS) component) and/or a sensor for sensing information (e.g., an accelerometer, a gyroscope, an actuator, or another type of position or environment sensor). Output component 230 can include a component that provides output information from device 200 (e.g., a display, a speaker, a haptic feedback component, and/or an audio or visual indicator).

Communication component 235 may include one or more transceiver-like components (e.g., a transceiver and/or a separate receiver and transmitter) that enables device 200 to communicate with other devices, such as via a wired connection, a wireless connection, or a combination of wired and wireless connections. Communication component 235 may permit device 200 to receive information from another device and/or provide information to another device. For example, communication component 235 may include an Ethernet interface, an optical interface, a coaxial interface, an infrared interface, a radio frequency interface, a universal serial bus (USB) interface, a wireless local area interface (e.g., a Wi-Fi interface or a BLE interface), and/or a cellular network interface.

Communication component 235 may include one or more antennas for receiving wireless radio frequency (RF) signals transmitted from one or more other devices, cloud networks, and/or the like. The antenna may be a single antenna or an antenna array (e.g., antenna phased array) that can facilitate simultaneous transmit and receive functionality. The antenna may be an omnidirectional antenna such that signals can be received from and transmitted in all directions. The wireless signals may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network.

The one or more transceiver-like components (e.g., a wireless transceiver) of the communication component 235 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals into a baseband or intermediate frequency and can convert the RF signals to the digital domain.

In some cases, a CODEC may be implemented (e.g., by the processor 210) to encode and/or decode data transmitted and/or received using the one or more wireless transceivers. In some cases, encryption-decryption may be implemented (e.g., by the processor 210) to encrypt and/or decrypt data (e.g., according to the Advanced Encryption Standard (AES) and/or Data Encryption Standard (DES) standard) transmitted and/or received by the one or more wireless transceivers.

In some aspects, device 200 may represent an ESL. The ESL may include a battery in addition to the aforementioned components. In some aspects, the output component 230 of the ESL may be an electronic paper (e-paper) display or a liquid crystal display (LCD).

Device 200 may perform one or more processes described herein. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication component 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

As previously mentioned, in ESL systems, PAs are often utilized to provide regular and predictable payload transmissions from a central device (e.g., which may be in the form of a network device, such as an access point) to one or more peripheral devices (e.g., which may each be in the form of a wireless communication device, such as an ESL). PAs can be used to issue information from a central device to multiple peripheral devices, which may be within one or more groups of peripheral devices. PAs are generally unidirectional (e.g., unidirectional transmissions) such that PAs are transmitted only one-way from a central device to one or more peripheral devices.

Periodic Advertisement with Response (PAwR) was introduced to ESL systems to provide bidirectionality (e.g., bidirectional transmissions between a central device and one or more peripheral devices). Peripheral devices synchronized within a group of peripheral devices can be addressed by a central device on a synchronized channel (e.g., a synchronized frequency channel between the central device and the peripheral devices) whenever the central device determines to send (e.g., transmit) a request (e.g., a PA containing a synchronization message transmitted on the synchronized channel) to the peripheral devices. If a response from a peripheral device is expected by the central device (e.g., the synchronization message from the central device requests a response from a specific peripheral device), the particular peripheral device will respond in a specific response slot, based on where the peripheral device appeared within a sequence contained within the synchronization message transmitted by the central device.

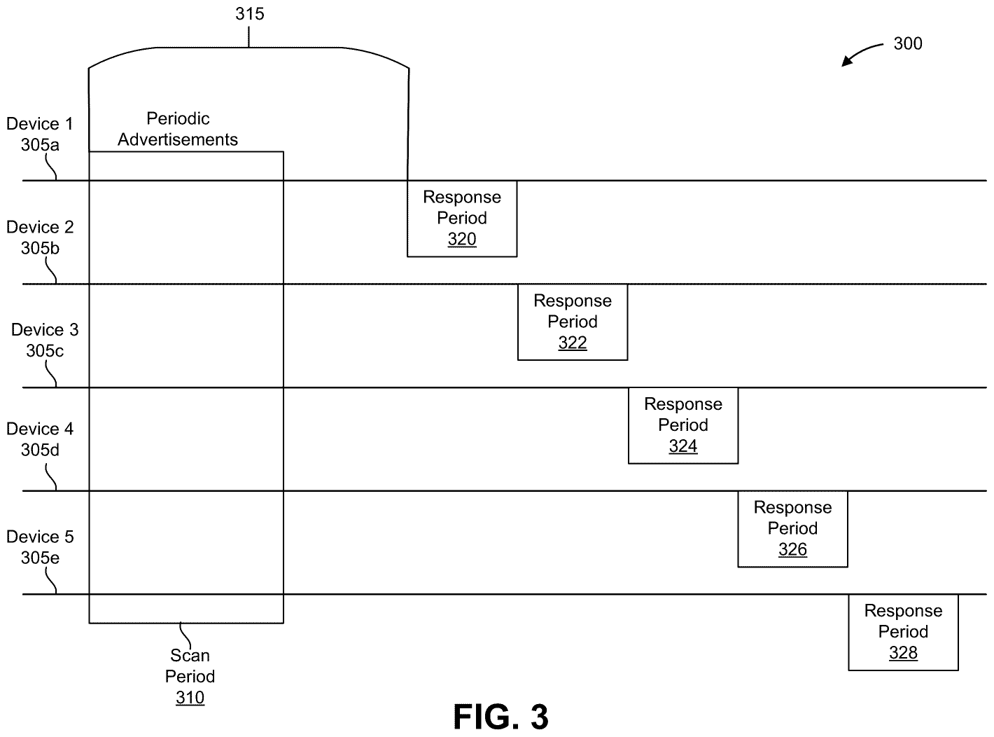

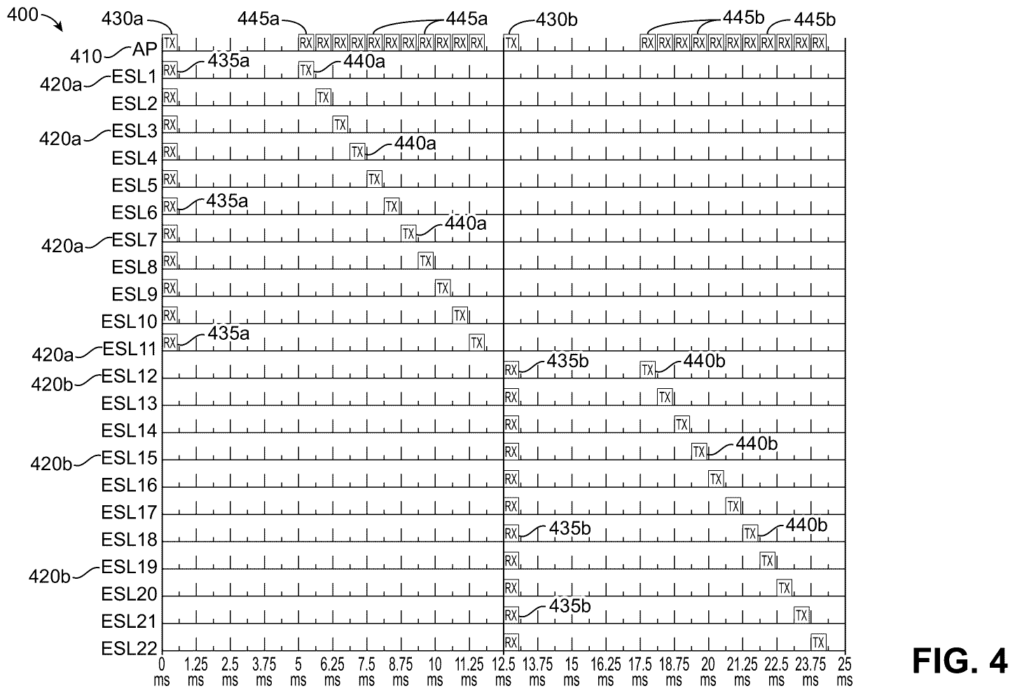

FIGS. 3 and 4 show signaling diagrams illustrating examples of PAwR in an ESL system. In particular, the signaling diagram 300 of FIG. 3 shows an example PAwR for a group of wireless network devices (e.g., device 1 305a, device 2 305b, device 3 305c, device 4 305d, and device 5 305e), and the signaling diagram of FIG. 4 shows an example PAwR for two groups of wireless network devices 420a, 420b (e.g., a first group including ESL1 to ESL 11, and a second group including ESL 12 to ESL 22). Specifically, FIG. 3 is a signal timing diagram illustrating a portion of a communication between an access point (e.g., access point 110) and wireless communication devices 120 (e.g., ESLs). With reference to FIG. 1, the signal sequence illustrated in FIG. 3 may be implemented by one or more of the communication connections, access points 110, and/or wireless communication devices 120 of FIG. 1.

The devices (e.g., device 1 305a, device 2 305b, device 3 305c, device 4 305d, and device 5 305e) of FIG. 3 may be selected from wireless communication devices 120 of FIG. 1, and may each receive a periodic advertisement (PA) in a scan period 310. The scan period 310 may occur in regularly scheduled intervals and may be repeated periodically such that the devices (e.g., device 1 305a, device 2 305b, device 3 305c, device 4 305d, and device 5 305e) can awaken to scan for messages during this repeated scan period 310. An access point (e.g., access point 110 of FIG. 1) may provide periodic advertisements (PAs) via broadcast or multi-cast to the devices (e.g., device 1 305a, device 2 305b, device 3 305c, device 4 305d, and device 5 305e) in the scan period 310. For an access point (e.g., access point 110 of FIG. 1), the scan period 310 can be its primary transmission period. In some cases, the scan period 310 may not be a fixed time because the access point (e.g., access point 110 of FIG. 1) may send different lengths of data from the start of the scan period 310.

The transmission may include multiple advertisements in a train. One or more portions of the advertisements may be directed to one or more of the devices (e.g., device 1 305a, device 2 305b, device 3 305c, device 4 305d, and device 5 305e). The devices (e.g., device 1 305a, device 2 305b, device 3 305c, device 4 305d, and device 5 305e) may decode or filter the messages intended for each specific device and transmitted during the period when all devices are receiving. In this way, the devices (e.g., device 1 305a, device 2 305b, device 3 305c, device 4 305d, and device 5 305e) may be reprogrammed, updated, and/or sent requests from an access point (e.g., access point 110 of FIG. 1) or relayed from another device (e.g., management entity 130 of FIG. 1) through the access point (e.g., access point 110 of FIG. 1). The periodic advertisement (PA) from the access point (e.g., access point 110 of FIG. 1) may set a response period for one or more of the devices (e.g., device 1 305a, device 2 305b, device 3 305c, device 4 305d, and device 5 305e).

As illustrated, the devices (e.g., device 1 305a, device 2 305b, device 3 305c, device 4 305d, and device 5 305e) are each assigned a response period 320, 322, 324, 326, 328 in the time after the scan period 310. In some cases, the assignment of the response period to a particular device may not be permanent. In some aspects, the assignment may be inferred from a payload of a synchronization message. The first response period 320 may begin following an idle time 315 after the scan period 310, with the idle period being long enough to provide the transmitter device an opportunity to do other Bluetooth related activities. The assigned response periods may also be limited to or designate a particular frequency of the channels on which to respond. For example, in FIG. 3, device 1 305a is assigned response period 320, device 2 305b is assigned response period 322, device 3 305c is assigned response period 324, device 4 305d is assigned response period 326, and device 5 305e is assigned response period 328. The access point (e.g., access point 110 of FIG. 1) may store attributes of the devices (e.g., device 1 305a, device 2 305b, device 3 305c, device 4 305d, and device 5 305e), including whether a device is able to transmit or respond. The PA signaling followed by responses can be referred to as periodic advertisement with multiple responses (PAwMR).

For example, device 3 305c (e.g., wireless communication device 120 of FIG. 1) may be an ESL and may receive a price update in a PA from the access point (e.g., access point 110 of FIG. 1) in scan period 310. The PA received at device 3 305c may include a designated start time for the response period 324 or may include a schedule of response start times for devices including device 3 305c. The response by device 3 305c to the access point (e.g., access point 110 of FIG. 1) may include an acknowledgement, a status code, and/or other information such as battery life, received signal strength, and/or an error notification. The response by device 3 305c may include information to be relayed to another device by the access point (e.g., access point 110 of FIG. 1). The response may include a packet with a header and may conform to any of the Bluetooth protocols. A response may be transmitted in a data channel of the Bluetooth protocol to the access point (e.g., access point 110 of FIG. 1). Both the PA and the responses from all of the devices (e.g., device 1 305a, device 2 305b, device 3 305c, device 4 305d, and device 5 305e) may use channels of the Bluetooth protocol.

A device (e.g., device 5 305e) that has been assigned a response period may not respond and may determine that it has nothing to signal. In other words, the devices (e.g., device 1 305a, device 2 305b, device 3 305c, device 4 305d, and device 5 305e) may determine what response, if any, is required and may or may not respond to a request sent from the access point (e.g., access point 110 of FIG. 1). The response periods 320, 322, 324, 326, 328 may be assigned based on a request for such a period in an open transmission time, the request being sent to the access point (e.g., access point 110 of FIG. 1). The response periods 320, 322, 324, 326, 328 may be assigned based on which devices have been requested by the access point (e.g., access point 110 of FIG. 1) to send data or acknowledgements. The PA messages and responses may be frequency-hopped, time synchronized channels, and/or extended channels of the advertisement channels in Bluetooth.

As previously mentioned, FIG. 4 shows an example PAwR for two groups of wireless network devices 420a, 420b (e.g., a first group including EL1 to ESL 11, and a second group including ESL 12 to ESL 22). In particular, FIG. 4 is a signaling diagram 400 illustrating an example of communication transmissions between a network device 410 (e.g., a central device, which may be an access point) and two groups of wireless communication devices 420a, 420b (e.g., peripheral devices, which may be ESLs). With reference to FIG. 1, the signal sequence illustrated in FIG. 4 may be implemented by one or more of the communication connections, access points 110, and/or wireless communication devices 120 of FIG. 1.

In FIG. 4, the signaling diagram is shown in the form of a graph with an x-axis denoting time in milliseconds (ms) and a y-axis denoting specific wireless communication devices 420a, 420b (e.g., ESL1, ESL 2, ESL 3, ESL 4, ESL 5, ESL 6, ESL 7, ESL 8, ESL 9, ESL 10, ESL 11, ESL 12, ESL 13, ESL 14, ESL 15, ESL 16, ESL 17, ESL 18, ESL 19, ESL 20, ESL 21, and ESL 22). In particular, the x-axis of the graph of FIG. 4 denotes time starting from 0 ms and ending at 25 ms. The time can be divided into two subframes, which are each a length of 12.5 ms. As such, the two subframes may include a first subframe from 0 ms to 12.5 ms, and a second subframe from 12.5 ms to 25 ms. In one or more examples, there may be more or less than two subframes as is shown in FIG. 4, and/or each subframe may be longer or shorter than 12.5 ms as shown in FIG. 4.

In one or more examples, the wireless communication devices 420a, 420b (e.g., peripheral devices) may be assigned (e.g., by the network device 410 and/or by a network entity, such as a management entity) to different groups (e.g., two groups) of wireless communication devices 420a, 420b. For example, wireless communication devices 420a (e.g., ESL1, ESL 2, ESL 3, ESL 4, ESL 5, ESL 6, ESL 7, ESL 8, ESL 9, ESL 10, and ESL 11) may be assigned to a first group (e.g., group 1), and wireless communication devices 420b (e.g., ESL 12, ESL 13, ESL 14, ESL 15, ESL 16, ESL 17, ESL 18, ESL 19, ESL 20, ESL 21, and ESL 22) may be assigned to second group (e.g., group 2).

In FIG. 4, during operation for PAwR, at time 0 ms for the first subframe of time, the network device 410 (e.g., a central, such as an AP) may transmit 430a to a first group (e.g., group 1) of wireless communication devices 420a (e.g., ESL 1, ESL 2, ESL 3, ESL 4, ESL 5, ESL 6, ESL 7, ESL 8, ESL 9, ESL 10, and ESL 11) a PA containing a synchronization message (e.g., an AP synchronization message) over a synchronized channel between the network device 410 and the wireless communication devices 420a, 420b. As noted previously, a synchronization message can include one or more commands. For instance, a command can include an operational code (OpCode) and parameters associated with the command. At time 0 ms, the first group of wireless communication devices 420a (e.g., ESL 1, ESL 2, ESL 3, ESL 4, ESL 5, ESL 6, ESL 7, ESL 8, ESL 9, ESL 10, and ESL 11) can receive 435a the PA containing the synchronization message over the synchronized channel.

In one or more examples, the network device 410 may be configured to transmit PAs at a specified time interval (e.g., a subframe of time), such as at every 12.5 ms as is shown in FIG. 4. In one or more examples, the specified time interval (e.g., a subframe) may be shorter or longer than the 12.5 ms as is shown in FIG. 4. The wireless communication devices 420a, 420b may respond to a PA by using their specific respective response slot in time.

In one or more examples, the synchronization message transmitted 430a to the first group (e.g., group 1) of wireless communication devices 420a (e.g., ESL 1, ESL 2, ESL 3, ESL 4, ESL 5, ESL 6, ESL 7, ESL 8, ESL 9, ESL 10, and ESL 11) may indicate a respective response slot for one or more of the wireless communication devices 420a (e.g., ESL 1, ESL 2, ESL 3, ESL 4, ESL 5, ESL 6, ESL 7, ESL 8, ESL 9, ESL 10, and/or ESL 11) in the first group to use to transmit 440a a response to the network device 410. If a wireless communication device 420a (e.g., ESL 1, ESL 2, ESL 3, ESL 4, ESL 5, ESL 6, ESL 7, ESL 8, ESL 9, ESL 10, and ESL 11) is addressed within the synchronization message, the wireless communication device 420a (e.g., ESL 1, ESL 2, ESL 3, ESL 4, ESL 5, ESL 6, ESL 7, ESL 8, ESL 9, ESL 10, and ESL 11) can respond (e.g., transmit 440a) in its respective response slot, as indicated within the synchronization message.

For example, the synchronization message may indicate a specific sequence for one or more of the wireless communication devices 420a (e.g., ESL 1, ESL 2, ESL 3, ESL 4, ESL 5, ESL 6, ESL 7, ESL 8, ESL 9, ESL 10, and/or ESL 11) to respond (e.g., transmit 440a) in time (e.g., responding after 5 ms has elapsed after the start of the subframe at response slots located every 0.625 ms). For example, the sequence may indicate that wireless communication device 420a (e.g., ESL 1) should respond in a response slot located at 5 ms, wireless communication device 420a (e.g., ESL 2) should respond in a response slot located at 5.625 ms, wireless communication device 420a (e.g., ESL 3) should respond in a response slot located at 6.25 ms, wireless communication device 420a (e.g., ESL 4) should respond in a response slot located at 6.875 ms, wireless communication device 420a (e.g., ESL 5) should respond in a response slot located at 7.5 ms, wireless communication device 420a (e.g., ESL 6) should respond in a response slot located at 8.125 ms, wireless communication device 420a (e.g., ESL 7) should respond in a response slot located at 8.75 ms, wireless communication device 420a (e.g., ESL 8) should respond in a response slot located at 9.375 ms, wireless communication device 420a (e.g., ESL 9) should respond in a response slot located at 10 ms, wireless communication device 420a (e.g., ESL 10) should respond in a response slot located at 10.625 ms, and wireless communication device 420a (e.g., ESL 11) should respond in a response slot located at 11.25 ms.

After the wireless communication devices 420a (e.g., ESL 1, ESL 2, ESL 3, ESL 4, ESL 5, ESL 6, ESL 7, ESL 8, ESL 9, ESL 10, and ESL 11) have received 435a the PA containing the synchronization message from the network device 410, according to the sequence specified within the synchronization message, the one or more wireless communication devices 420a (e.g., ESL 1, ESL 2, ESL 3, ESL 4, ESL 5, ESL 6, ESL 7, ESL 8, ESL 9, ESL 10, and/or ESL 11) can transmit 440a their responses within their respective response slots. After the one or more wireless communication devices 420a (e.g., ESL 1, ESL 2, ESL 3, ESL 4, ESL 5, ESL 6, ESL 7, ESL 8, ESL 9, ESL 10, and/or ESL 11) have transmitted 440a their responses in their respective response time slots, the network device 410 can receive 445a their transmitted responses at those specific response slot times.

During operation for PAwR, at time 12.5 ms for the second subframe of time, the network device 410 may transmit 430b to a second group (e.g., group 2) of wireless communication devices 420b (e.g., ESL 12, ESL 13, ESL 14, ESL 15, ESL 16, ESL 17, ESL 18, ESL 19, ESL 20, ESL 21, and ESL 22) a PA containing a synchronization message over a synchronized channel between the network device 410 and the wireless communication devices 420a, 420b. In addition, at time 12.5 ms, the second group of wireless communication devices 420b (e.g., ESL 12, ESL 13, ESL 14, ESL 15, ESL 16, ESL 17, ESL 18, ESL 19, ESL 20, ESL 21, and ESL 22) can receive 435b the PA containing the synchronization message over the synchronized channel.

The synchronization message transmitted 430b to the second group (e.g., group 2) of wireless communication devices 420b (e.g., ESL 12, ESL 13, ESL 14, ESL 15, ESL 16, ESL 17, ESL 18, ESL 19, ESL 20, ESL 21, and ESL 22) may indicate a respective response slot for one or more of the wireless communication devices 420b (e.g., ESL 12, ESL 13, ESL 14, ESL 15, ESL 16, ESL 17, ESL 18, ESL 19, ESL 20, ESL 21, and/or ESL 22) in the second group to use to transmit 440b a response to the network device 410. If a wireless communication device 420b (e.g., ESL 12, ESL 13, ESL 14, ESL 15, ESL 16, ESL 17, ESL 18, ESL 19, ESL 20, ESL 21, and ESL 22) is addressed within the synchronization message, the wireless communication device 420b (e.g., ESL 12, ESL 13, ESL 14, ESL 15, ESL 16, ESL 17, ESL 18, ESL 19, ESL 20, ESL 21, and ESL 22) can respond (e.g., transmit 440b) in its respective response slot, as indicated within the synchronization message.

For example, the synchronization message may indicate a specific sequence for one or more of the wireless communication devices 420b (e.g., ESL 12, ESL 13, ESL 14, ESL 15, ESL 16, ESL 17, ESL 18, ESL 19, ESL 20, ESL 21, and/or ESL 22) to respond (e.g., transmit 440b) in time (e.g., responding after 5 ms has elapsed after the start of the subframe at response slots located every 0.625 ms). For example, the sequence may indicate that wireless communication device 420b (e.g., ESL 12) should respond in a response slot located at 17.5 ms, wireless communication device 420b (e.g., ESL 13) should respond in a response slot located at 18.125 ms, wireless communication device 420b (e.g., ESL 14) should respond in a response slot located at 18.75 ms, wireless communication device 420b (e.g., ESL 15) should respond in a response slot located at 19.375 ms, wireless communication device 420b (e.g., ESL 16) should respond in a response slot located at 20 ms, wireless communication device 420b (e.g., ESL 17) should respond in a response slot located at 20.625 ms, wireless communication device 420b (e.g., ESL 18) should respond in a response slot located at 21.25 ms, wireless communication device 420b (e.g., ESL 19) should respond in a response slot located at 21.875 ms, wireless communication device 420b (e.g., ESL 20) should respond in a response slot located at 22.5 ms, wireless communication device 420b (e.g., ESL 21) should respond in a response slot located at 23.125 ms, and wireless communication device 420b (e.g., ESL 22) should respond in a response slot located at 23.75 ms.

After the wireless communication devices 420b (e.g., ESL 12, ESL 13, ESL 14, ESL 15, ESL 16, ESL 17, ESL 18, ESL 19, ESL 20, ESL 21, and ESL 22) have received 435b the PA containing the synchronization message from the network device 410, according to the sequence specified within the synchronization message, the one or more wireless communication devices 420b (e.g., ESL 12, ESL 13, ESL 14, ESL 15, ESL 16, ESL 17, ESL 18, ESL 19, ESL 20, ESL 21, and/or ESL 22) may transmit 440b their responses within their respective response slots. After the one or more wireless communication devices 420b (e.g., ESL 12, ESL 13, ESL 14, ESL 15, ESL 16, ESL 17, ESL 18, ESL 19, ESL 20, ESL 21, and/or ESL 22) have transmitted 440b their responses in their respective response time slots, the network device 410 can receive 445b their transmitted responses at those specific response slot times. The PAwR may continue similarly for subsequent subframes of time.

As previously mentioned, in some cases, an ESL may be physically moved to a new location. For example, the ESL may be moved from one location in a retail store (e.g., a particular shelf or a storage area) to a different location within the store. Changing the location of the ESL can result in the ESL losing synchronization with (e.g., due to being out of communications range) a current access point for which the ESL is associated. Such a loss in synchronization can interrupt the management entity's ability to control the ESL, and the ESL's ability to report to the management entity. After determining a network outage (e.g., caused by the loss of synchronization), the ESL can perform an onboarding procedure to reestablish synchronization with an access point.

PAwR can allow BLE peripheral devices (e.g., ESLs) to perform an onboarding procedure to synchronize with a central device (e.g., an access point) and, as such, be able to respond to periodic transmissions from the central device. For example, for an onboarding procedure in a retail setup (e.g., within a retail store or warehouse environment), an access point can act as a central device, and ESLs can act as peripheral devices.

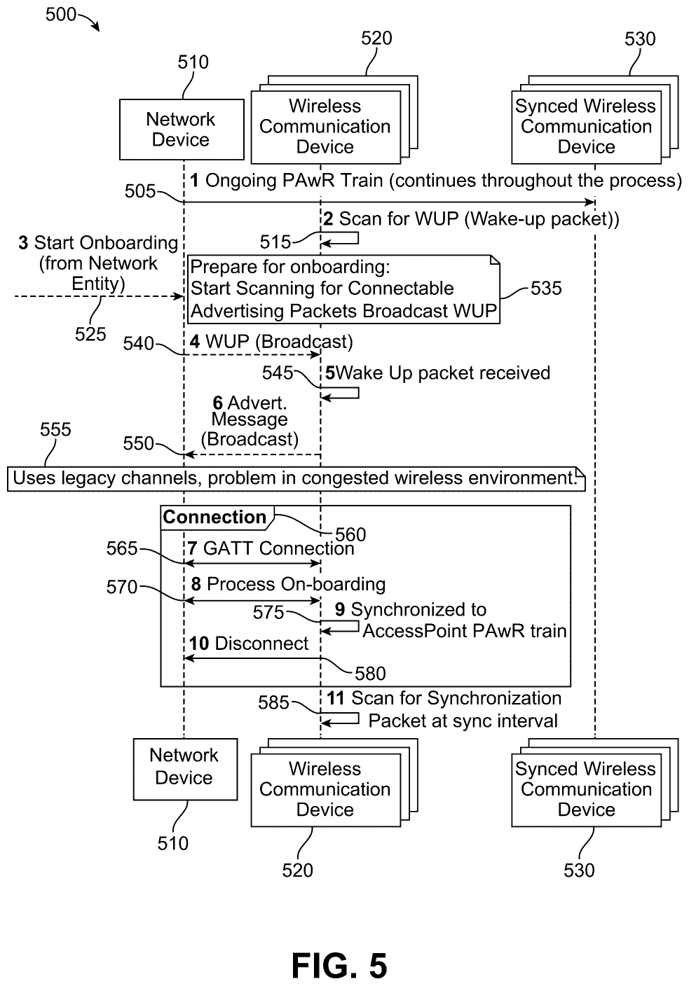

FIG. 5 shows an example of communication transmissions for fast onboarding of wireless communication devices (e.g., peripheral devices, such as BLE devices in the form of ESLs), such as within a retail setup. In particular, FIG. 5 is a signaling diagram illustrating an example of communication transmissions 500 between a network device 510 (e.g., an access point) and wireless communication devices 520 (e.g., new ESLs) using legacy channels for onboarding (and synchronization) of the wireless communication devices 520 to the network device 510. In FIG. 5, a system is shown to include a network device 510 (e.g., a central device, such as in the form of an access point), a plurality of wireless communication devices 520 (e.g., peripheral devices that are not yet synchronized to the network device 510, and that may be in the form of ESLs and referred to as new ESLs), and a plurality of synchronized wireless communication devices 530 (e.g., the peripheral devices that have been synchronized to the network device 510 and that may be referred to as synchronized ESLs). In one or more examples, the system of FIG. 5 may include more or less than the number of (and/or different types of) network devices 510, wireless communication devices 520, and/or synchronized wireless communication devices 530, than as shown in FIG. 5.

During operation of the system of FIG. 5, for onboarding the wireless communication devices 520 (e.g., the new ESLs) to the network device 510 (e.g., access point), the network device 510 can transmit (e.g., broadcast) an ongoing PAwR train 505, which can continue throughout the entire onboarding process of FIG. 5. When the wireless communication devices 520 are powered, the wireless communication devices 520 can perform a scan 515 to receive a wake up packet (WUP) transmitted from the network device 510. In one or more examples, the WUP can contain advertisement parameters (e.g., interval and duration parameters) for the wireless communication devices 520.

In one or more examples, a network entity (e.g., ME) can send (e.g., transmit) to the network device 510 a command to start onboarding 525 at least one of the wireless communication devices 520. After receiving the command to start onboarding from the network entity, the network device 510 can prepare for the onboarding 535 by starting to scan for advertisement messages (e.g., CAPs) transmitted by one or more of the wireless communication devices 520 on one or more legacy channels. The network device 510 can transmit (e.g., broadcast) 540 a WUP to the wireless communication devices 520 on one or more of the legacy channels.

After receiving the WUP 545 from the network device 510, the wireless communication devices 520 can transmit (e.g., broadcast) one or more advertisement messages (e.g., one or more CAPs) 550 on one or more legacy channels, based on parameters (e.g., interval and duration parameters) received within the WUP. In one or more examples, the one or more transmissions (e.g., of the WUP and the CAP(s)) on the one or more legacy channels can congest the wireless environment 555.

The network device 510 can scan on the legacy channels to receive the CAPs from the wireless communication devices 520, and then establish a synchronized connection 560 (e.g., a GATT connection 565) with one or more of the advertising wireless communication devices 520 to perform an onboarding process 570 of those wireless communication devices 520. The onboarding process 570 involves the transfer of PAST information, where the network device 510 can share its PAwR timing with the wireless communication devices 520.

In one or more examples, when multiple network devices (e.g., access points) receive a CAP from a wireless communication device (e.g., an ESL), the network devices (e.g., access points) can report the received CAP to a network entity (e.g., ME). The network entity (e.g., ME) can then shortlist (e.g., specify) one of the network devices (e.g., access points, such as network device 510 in the form of an access point) to onboard the wireless communication device (e.g., the ESL).

Referring back to FIG. 5, after the wireless communication devices 520 receive the PAST information (e.g., including the PAwR timing of the network device 510) and are onboarded onto the network device 510, the wireless communication devices 520 can be synchronized 575 to the network device 510 and, as such, will become synchronized wireless communication devices 530.

The synchronized wireless communication devices 530 may disconnect 580 and, as such, become unsynchronized with the network device 510. The wireless communication devices 520 can then scan 585 for a synchronization packet transmitted from the network device 510 at a synchronization interval of the PAwR train to re-onboard onto the network device 510.

In one or more examples, the GATT connection 565 process of FIG. 5 with the advertising wireless communication devices 520 to perform onboarding of those wireless communication devices 520 has a high dependency on the legacy frequency spectrum (e.g., legacy channels), and takes a longer duration of time to complete as compared to a GATT connection with already synchronized wireless communication devices (e.g., synchronized wireless communication devices 530).

In one or more examples, for this onboarding process of FIG. 5, the wireless communication devices 520 are transmitting CAPs over the legacy channels until the onboarding process is completed. In an environment where multiple wireless communication devices (e.g., ESLs) are onboarded together onto a network device (e.g., an access point), such as shown in FIG. 5, the onboarding procedure can consume significant computing resources (e.g., processor resources, memory resources, and/or battery resources, among other examples) of the wireless communication devices and/or the network device, and the frequent advertisements (e.g., CAPs) by the wireless communication devices can result in spectral pollution on the legacy channels of the wireless network, packet collisions until the onboarding procedure completes, and an increased onboarding time.

In one or more aspects, the systems and techniques provide a fast onboarding in a wireless communication device system (e.g., an AP-ESL system). In one or more examples, the systems and techniques utilize a modal transition in an access point mode to reduce the dependency on the legacy channels for onboarding of ESLs. In some examples, the systems and techniques indicate usage of a response slot for an ESL to communicate with an access point for the onboarding of the ESL to that access point.

In one or more examples, the systems and techniques can allow for a dynamic capability to distribute the ESLs across groups using auxiliary advertisements. In some examples, an access point can use a synchronized channel for creating a connection with an ESL for onboarding that ESL. In one or more examples, the systems and techniques allow for less congestion on the legacy channels until the onboarding is completed, a faster onboarding, and a reduced number of CAP transmissions, which can lead to reduced power consumption by the ESLs.

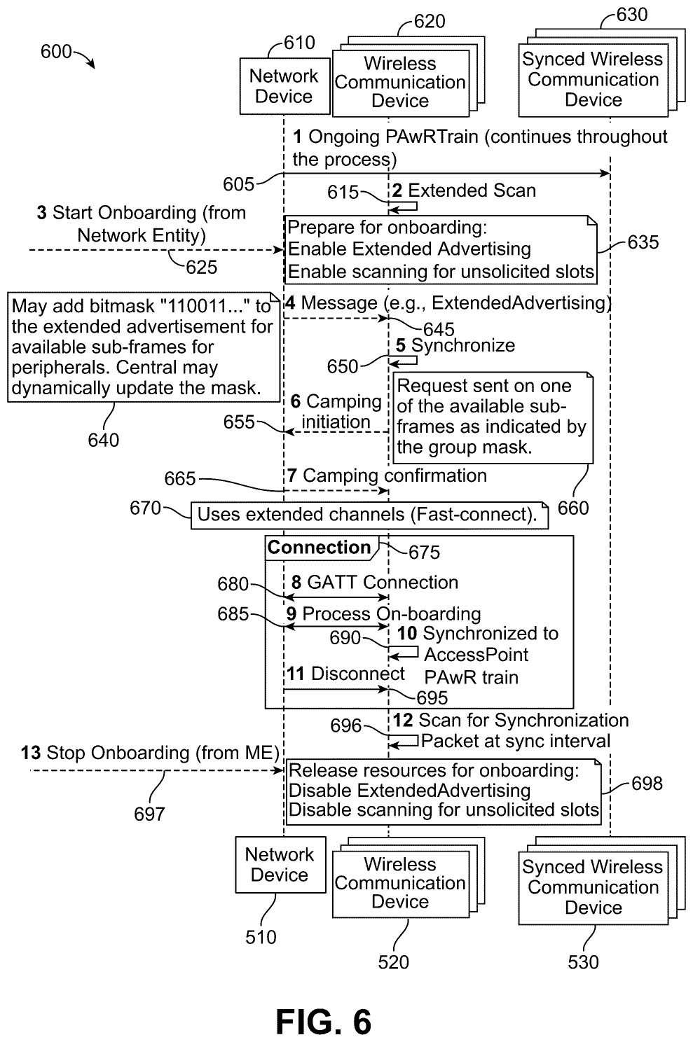

FIG. 6 shows an example of communication transmissions for fast onboarding of wireless communication devices (e.g., peripheral devices, such as BLE devices in the form of ESLs), such as within a retail setup, where the communication transmissions utilize extended channels. In particular, FIG. 6 is a signaling diagram illustrating an example of communication transmissions 600 between a network device 610 (e.g., an access point) and wireless communication devices 620 (e.g., ESLs) using legacy channels and extended channels for onboarding of the wireless communication devices 620 to the network device 610. In FIG. 6, a system is shown to include a network device 610 (e.g., a central device, such as in the form of an access point), a plurality of wireless communication devices 620 (e.g., peripheral devices that are not yet synchronized to the network device 610, and that may be in the form of ESLs and referred to as new ESLs), and a plurality of synchronized wireless communication devices 630 (e.g., the peripheral devices that have been synchronized to the network device 610 and that may be referred to as synchronized ESLs). In one or more examples, the system of FIG. 6 may include more or less than the number of (and/or different types of) network devices 610, wireless communication devices 620, and/or synchronized wireless communication devices 630, than as shown in FIG. 6.

During operation of the system of FIG. 6, for onboarding the wireless communication devices 620 (e.g., the new ESLs) to the network device 610 (e.g., access point), the network device 610 may transmit (e.g., broadcast), on one or more legacy channels, an ongoing PAwR train 605, which may continue throughout the entire onboarding process of FIG. 6. When the wireless communication devices 620 are powered, the wireless communication devices 620 can perform an extended scan 615 for a PAwR train from a network device in their vicinity.

In one or more examples, a network entity (e.g., ME) can send (e.g., transmit) to the network device 610 a command to start onboarding 625 at least one of the wireless communication devices 620. After receiving the command to start onboarding from the network entity, the network device 610 can prepare for the onboarding at operation 635 by enabling extended advertising and enabling scanning for unsolicited slots (e.g., peripheral initiated slots) on extended channels.

The network device 610 can then transmit (e.g., broadcast) a message 645 (e.g., an extended advertising message, such as in the form of an extended advertising packet) to the wireless communication devices 620 on one or more legacy channels. The message 645 (e.g., extended advertising message) can include a plurality of available channel subframes (e.g., out of the total 128 subframes) for onboarding to the network device 610. In one or more examples, the message 645 (e.g., extended advertising message) can be transmitted within the PAwR train. In some examples, the message 645 (e.g., extended advertising message) can include data (e.g., ACAD data) associated with the PAwR train (e.g., train specific ACAD data). In one or more examples, as shown at operation 640, the network device 610 may include a bit mask (e.g., a binary number, such as 11011 . . . ) in the message 645 (e.g., extended advertising message), where the plurality of available channel subframes (e.g., extended channels) are coded within the bit mask. In some cases, the network device 610 may update the bitmask (e.g., dynamically update the bitmask) prior to sending the message 645.

After one or more wireless communication devices of the plurality of wireless communication devices 620 receive the message 645 (e.g., extended advertising message) from the network device 610, the one or more wireless communication devices 620 can synchronize 650 with an available PAwR train in their vicinity (e.g., the PAwR train associated with network device 610). As such, the one or more wireless communication devices 620 may select a network device (e.g., network device 610) in their vicinity to onboard to.

After the one or more wireless communication devices 620 synchronize 650 to the PAwR train associated with network device 610, the one or more wireless communication devices 620 can transmit to the network device 610 an initiation request message (e.g., a camping initiation message 655) requesting synchronization with the network device 610. In one or more examples, as shown at operation 660, the initiation request message (e.g., a camping initiation message 655) can be transmitted on one or more peripheral initiated slots of one or more of the available channel subframes of the plurality of available channel subframes (e.g., extended channels) as indicated within the bit mask.

In one or more examples, the initiation request message (e.g., the camping initiation message 655) may include wireless communication device identification information (e.g., MAC address identification and/or group address identification associated with the particular wireless communication device 620) and cryptographic information (e.g., an asymmetric public key). After the network device 610 receives the initiation request message (e.g., the camping initiation message 655), the network device 610 can transmit the payload (e.g., wireless communication devices identification information and cryptographic information) of the initiation request message to the network entity (e.g., the ME). After receiving the payload of the initiation request message from the network device 610, the network entity (e.g., ME) can analyze the information in the payload to determine whether or not the one or more wireless communication devices 620 are authenticated (e.g., valid).

Upon a successful authentication of the one or more wireless communication devices 620 by the network entity (e.g., ME), the network entity (e.g., ME) can transmit to the network device 610 an authentication message notifying the network device 610 that the one or more wireless communication devices 620 are authenticated (e.g., valid). After the network device 620 receives the authentication notification message indicating that the one or more wireless communication devices 620 are authenticated (e.g., valid), the network device 610 can transmit, on one or more of the available channel subframes of the plurality of available channel subframes (e.g., extended channels), to the one or more wireless communication devices 620 an initiation response message (e.g., a camping confirmation message 665) confirming the synchronization with the network device 610. In one or more examples, the initiation response message (e.g., a camping confirmation message 665) may include a command for the one or more wireless communication devices 620 to latch onto different subframe numbers from each other to distribute the one or more wireless communication devices 620 across groups.

The network device 610 can then establish a synchronized connection 675 (e.g., a GATT connection 680) with one or more of the wireless communication devices 620 to perform an onboarding process 685 of those wireless communication devices 620. In one or more examples, the connection 675 (e.g., a fast connection) may be performed on one or more of the available channel subframes (e.g., the extended channels 670). The onboarding process 685 involves the transfer of PAST information, where the network device 610 can share its PAwR timing with the wireless communication devices 620.

In one or more examples, when multiple network devices (e.g., access points) receive an initiation request message (e.g., a camping initiation message 655) from a wireless communication device (e.g., an ESL), the network devices (e.g., access points) can report the received initiation request message to a network entity (e.g., ME). The network entity (e.g., ME) can then shortlist (e.g., specify) one of the network devices (e.g., access points, such as network device 610 in the form of an access point) to onboard the wireless communication device (e.g., the ESL).

Referring back to FIG. 6, after the wireless communication devices 620 receive the PAST information (e.g., including the PAwR timing of the network device 610) and are onboarded onto the network device 610, the wireless communication devices 620 can be synchronized 690 to the network device 610 and, as such, will become synchronized wireless communication devices 630.

The synchronized wireless communication devices 630 can disconnect 695 and, as such, become unsynchronized with the network device 610. The wireless communication devices 620 can then scan 696 for a synchronization packet transmitted from the network device 510 at a synchronization interval of the PAwR train to re-onboard onto the network device 510.

In one or more examples, the network entity (e.g., ME) can send (e.g., transmit) to the network device 610 a command to stop onboarding 697 the one or more wireless communication devices 620. After receiving the command to stop onboarding from the network entity, the network device 610 can release the resources for the onboarding, disable the extended advertising, and disable the scanning for unsolicited slots 698.

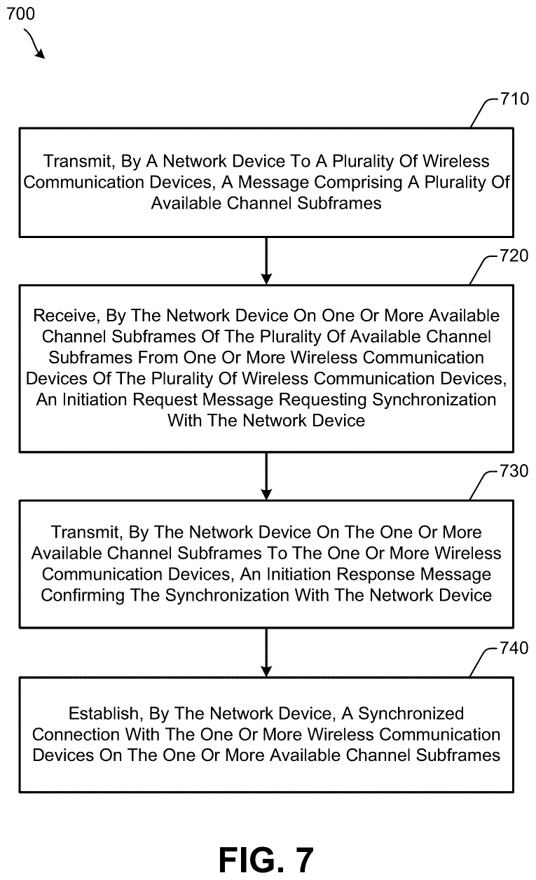

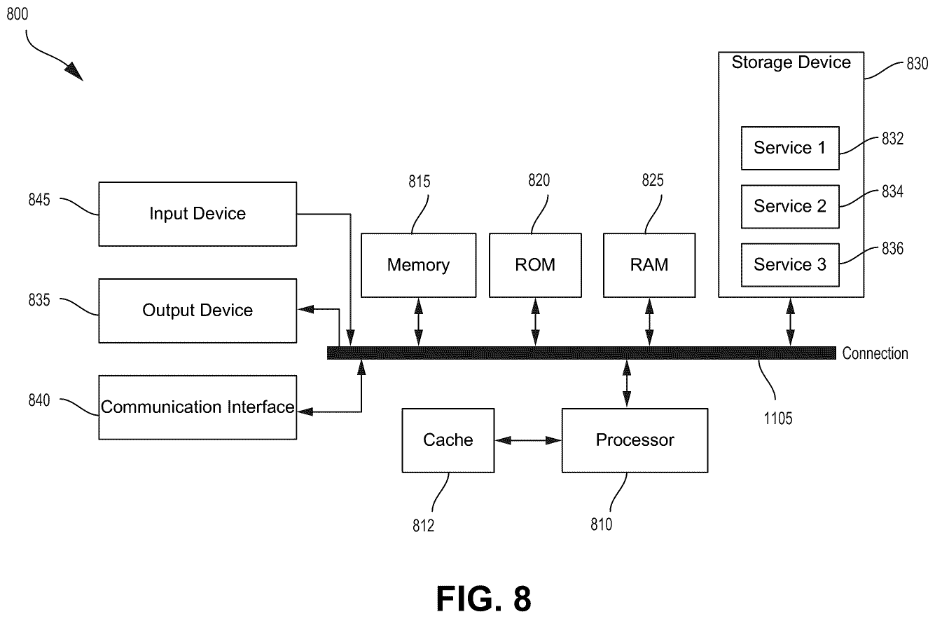

FIG. 7 is a flow chart illustrating an example of a process 700 for fast onboarding in a wireless communication device system. The process 700 can be performed by a network device (e.g., access point 110 of FIG. 1, device 200 of FIG. 2, network device 410 of FIG. 4, or computing system 800 of FIG. 8) or by a component or system (e.g., a chipset) of the network device. The operations of the process 700 may be implemented as software components that are executed and run on one or more processors (e.g., processor 810 of FIG. 8 or other processor(s)). Further, the transmission and reception of signals by the network device in the process 700 may be enabled, for example, by one or more antennas and/or one or more transceivers (e.g., wireless transceiver(s)).

At block 710, the network device (or component thereof) can transmit (or output for transmission), to a plurality of wireless communication devices, a message (e.g., message 645 of FIG. 6) including a plurality of available channel subframes. In some aspects, the message is transmitted within a periodic advertisement with response (PAwR) train. In some cases, the message further comprises data associated with the PAwR train (e.g., train specific ACAD data). In some examples, the message is transmitted on a legacy channel (e.g., Bluetooth channels 37, 38, or 39). In some cases, the message is an extended advertising packet. In some cases, the plurality of available channel subframes are coded within a bit mask included in the message. For example, as shown at operation 640 of FIG. 6, the network device 610 may include a bit mask (e.g., a binary number, such as 11011 . . . ) in the message 645. The plurality of available channel subframes (e.g., extended channels) can be coded within the bit mask. In some cases, each wireless communication device of the plurality of wireless communication devices is a Bluetooth low energy (BLE) device.

At block 720, the network device (or component thereof) can receive, on one or more available channel subframes of the plurality of available channel subframes from one or more wireless communication devices of the plurality of wireless communication devices, an initiation request message requesting synchronization with the network device. In some cases, the initiation request message is a camping initiation message (e.g., camping initiation message 655 of FIG. 6). In some cases, the initiation request message includes wireless communication device identification information and cryptographic information.

At block 730, the network device (or component thereof) can transmit, on the one or more available channel subframes to the one or more wireless communication devices, an initiation response message confirming the synchronization with the network device. In some examples, the initiation response message is a camping confirmation message (e.g., camping confirmation message 665 of FIG. 6).

At block 740, the network device (or component thereof) can establish a synchronized connection (e.g., synchronized connection 675 of FIG. 6) with the one or more wireless communication devices on the one or more available channel subframes. In some aspects, the synchronized connection is a generate attribute profile (GATT) connection (e.g., the GATT connection 680 of FIG. 6). For instance, in such aspects, to establish the synchronized connection, the computing device (or component thereof) can establish a GATT connection.

In some cases, the computing device (or component thereof) can receive, from a network entity, a command to start onboarding (e.g., command to start onboarding 625 of FIG. 6) at least one of the plurality of wireless communication devices. In some examples, the network entity is a management entity (ME). In the example of FIG. 6, the network device 610 can prepare for the onboarding at operation 635 after receiving the command to start onboarding 625 from the network entity, such as by enabling extended advertising and enabling scanning for unsolicited slots (e.g., peripheral initiated slots) on extended channels. In some cases, the computing device (or component thereof) can receive, from a network entity, a command to stop onboarding (e.g., command to stop onboarding 697 of FIG. 6) the one or more wireless communication devices. In the example of FIG. 6, after receiving the command to stop onboarding from the network entity, the network device 610 can release the resources for the onboarding, disable the extended advertising, and disable the scanning for unsolicited slots 698.

As noted above, the process 700 may be performed by one or more computing devices or apparatuses. In some illustrative examples, the process 700 can be performed by access point 110 of FIG. 1, device 200 of FIG. 2, network device 410 of FIG. 4, and/or one or more computing devices or systems (e.g., the computing system 800 of FIG. 8). In some cases, such a computing device or apparatus may include a processor, microprocessor, microcomputer, or other component of a device that is configured to carry out the steps of the process 700. Such computing device may further include a network interface configured to communicate data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 700 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 700 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 8 is a block diagram illustrating an example of a computing system 800, which may be employed by the disclosed system for fast onboarding in a wireless communication device system. In particular, FIG. 8 illustrates an example of computing system 800, which can be for example any computing device making up internal computing system, a remote computing system, a camera, or any component thereof in which the components of the system are in communication with each other using connection 805. Connection 805 can be a physical connection using a bus, or a direct connection into processor 810, such as in a chipset architecture. Connection 805 can also be a virtual connection, networked connection, or logical connection.

In some aspects, computing system 800 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 800 includes at least one processing unit (CPU or processor) 810 and connection 805 that communicatively couples various system components including system memory 815, such as read-only memory (ROM) 820 and random access memory (RAM) 825 to processor 810. Computing system 800 can include a cache 812 of high-speed memory connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms. In some instances, multimodal systems can enable a user to provide multiple types of input/output to communicate with computing system 800.

Computing system 800 can include communications interface 840, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 840 may also include one or more range sensors (e.g., LIDAR sensors, laser range finders, RF radars, ultrasonic sensors, and infrared (IR) sensors) configured to collect data and provide measurements to processor 810, whereby processor 810 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 830 can include software services, servers, services, etc., that when the code that defines such software is executed by the processor 810, it causes the system to perform a function. In some aspects, a hardware service that performs a particular function can include the software component stored in a computer-readable medium in connection with the necessary hardware components, such as processor 810, connection 805, output device 835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:
Aspect 1. A network device for wireless communications, the network device comprising: at least one memory; and at least one processor coupled to the at least one memory and configured to: output, for transmission to a plurality of wireless communication devices, a message comprising a plurality of available channel subframes; receive, on one or more available channel subframes of the plurality of available channel subframes from one or more wireless communication devices of the plurality of wireless communication devices, an initiation request message requesting synchronization with the network device; output, for transmission on the one or more available channel subframes to the one or more wireless communication devices, an initiation response message confirming the synchronization with the network device; and establish a synchronized connection with the one or more wireless communication devices on the one or more available channel subframes.
Aspect 2. The network device of Aspect 1, wherein the at least one processor is configured to output the message for transmission within a periodic advertisement with response (PAwR) train.
Aspect 3. The network device of Aspect 2, wherein the message further comprises data associated with the PAwR train.
Aspect 4. The network device of any one of Aspects 1 to 3, wherein the at least one processor is configured to output the message for transmission on a legacy channel.
Aspect 5. The network device of any one of Aspects 1 to 4, wherein the message is an extended advertising packet.
Aspect 6. The network device of any one of Aspects 1 to 5, wherein the initiation request message is a camping initiation message, and wherein the initiation response message is a camping confirmation message.
Aspect 7. The network device of any one of Aspects 1 to 6, wherein the initiation request message comprises wireless communication device identification information and cryptographic information.
Aspect 8. The network device of any one of Aspects 1 to 7, wherein the plurality of available channel subframes are coded within a bit mask included in the message.
Aspect 9. The network device of any one of Aspects 1 to 8, wherein, to establish the synchronized connection, the at least one processor is configured to establish a generate attribute profile (GATT) connection.
Aspect 10. The network device of any one of Aspects 1 to 9, wherein the at least one processor is configured to receive, from a network entity, a command to start onboarding at least one of the plurality of wireless communication devices.
Aspect 11. The network device of Aspect 10, wherein the network entity is a management entity (ME).
Aspect 12. The network device of any one of Aspects 1 to 11, wherein the at least one processor is configured to receive, from a network entity, a command to stop onboarding the one or more wireless communication devices.
Aspect 13. The network device of any one of Aspects 1 to 12, wherein network device is an access point (AP).
Aspect 14. The network device of any one of Aspects 1 to 13, wherein each wireless communication device of the plurality of wireless communication devices is a Bluetooth low energy (BLE) device.
Aspect 15. A method for wireless communications at a network device, the method comprising: transmitting, by the network device to a plurality of wireless communication devices, a message comprising a plurality of available channel subframes; receiving, by the network device on one or more available channel subframes of the plurality of available channel subframes from one or more wireless communication devices of the plurality of wireless communication devices, an initiation request message requesting synchronization with the network device; transmitting, by the network device on the one or more available channel subframes to the one or more wireless communication devices, an initiation response message confirming the synchronization with the network device; and establishing, by the network device, a synchronized connection with the one or more wireless communication devices on the one or more available channel subframes.
Aspect 16. The method of Aspect 15, wherein the message is transmitted within a periodic advertisement with response (PAwR) train.
Aspect 17. The method of Aspect 16, wherein the message further comprises data associated with the PAwR train.
Aspect 18. The method of any one of Aspects 15 to 17, wherein the message is transmitted on a legacy channel.
Aspect 19. The method of any one of Aspects 15 to 18, wherein the message is an extended advertising packet.
Aspect 20. The method of any one of Aspects 15 to 19, wherein the initiation request message is a camping initiation message, and wherein the initiation response message is a camping confirmation message.
Aspect 21. The method of any one of Aspects 15 to 20, wherein the initiation request message comprises wireless communication device identification information and cryptographic information.
Aspect 22. The method of any one of Aspects 15 to 21, wherein the plurality of available channel subframes are coded within a bit mask included in the message.
Aspect 23. The method of any one of Aspects 15 to 22, wherein establishing the synchronized connection comprises establishing a generate attribute profile (GATT) connection.
Aspect 24. The method of any one of Aspects 15 to 23, further comprising receiving, by the network device from a network entity, a command to start onboarding at least one of the plurality of wireless communication devices.
Aspect 25. The method of Aspect 24, wherein the network entity is a management entity (ME).
Aspect 26. The method of any one of Aspects 15 to 25, further comprising receiving, by the network device from a network entity, a command to stop onboarding the one or more wireless communication devices.
Aspect 27. The method of any one of Aspects 15 to 26, wherein network device is an access point (AP).
Aspect 28. The method of any one of Aspects 15 to 27, wherein each wireless communication device of the plurality of wireless communication devices is a Bluetooth low energy (BLE) device.
Aspect 29. A non-transitory computer-readable medium having stored thereon instructions that, when executed by one or more processors, cause the one or more processors to perform operations according to any of Aspects 15 to 28.
Aspect 30. An apparatus for wireless communication, the apparatus including one or more means for performing operations according to any of Aspects 15 to 28.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. A network device for wireless communications, the network device comprising:
at least one memory; and
at least one processor coupled to the at least one memory and configured to:
output, for transmission to a plurality of wireless communication devices, a message comprising a plurality of available channel subframes;
receive, on one or more available channel subframes of the plurality of available channel subframes from one or more wireless communication devices of the plurality of wireless communication devices, an initiation request message requesting synchronization with the network device;
output, for transmission on the one or more available channel subframes to the one or more wireless communication devices, an initiation response message confirming the synchronization with the network device; and
establish a synchronized connection with the one or more wireless communication devices on the one or more available channel subframes.

2. The network device of claim 1, wherein the at least one processor is configured to output the message for transmission within a periodic advertisement with response (PAwR) train.

3. The network device of claim 2, wherein the message further comprises data associated with the PAwR train.

4. The network device of claim 1, wherein the at least one processor is configured to output the message for transmission on a legacy channel.

5. The network device of claim 1, wherein the message is an extended advertising packet.

6. The network device of claim 1, wherein the initiation request message is a camping initiation message, and wherein the initiation response message is a camping confirmation message.

7. The network device of claim 1, wherein the initiation request message comprises wireless communication device identification information and cryptographic information.

8. The network device of claim 1, wherein the plurality of available channel subframes are coded within a bit mask included in the message.

9. The network device of claim 1, wherein, to establish the synchronized connection, the at least one processor is configured to establish a generate attribute profile (GATT) connection.

10. The network device of claim 1, wherein the at least one processor is configured to receive, from a network entity, a command to start onboarding at least one of the plurality of wireless communication devices.

11. The network device of claim 10, wherein the network entity is a management entity (ME).

12. The network device of claim 1, wherein the at least one processor is configured to receive, from a network entity, a command to stop onboarding the one or more wireless communication devices.

13. The network device of claim 1, wherein network device is an access point (AP).

14. The network device of claim 1, wherein each wireless communication device of the plurality of wireless communication devices is a Bluetooth low energy (BLE) device.

15. A method for wireless communications at a network device, the method comprising:
transmitting, by the network device to a plurality of wireless communication devices, a message comprising a plurality of available channel subframes;
receiving, by the network device on one or more available channel subframes of the plurality of available channel subframes from one or more wireless communication devices of the plurality of wireless communication devices, an initiation request message requesting synchronization with the network device;
transmitting, by the network device on the one or more available channel subframes to the one or more wireless communication devices, an initiation response message confirming the synchronization with the network device; and
establishing, by the network device, a synchronized connection with the one or more wireless communication devices on the one or more available channel subframes.

16. The method of claim 15, wherein the message is transmitted within a periodic advertisement with response (PAwR) train.

17. The method of claim 16, wherein the message further comprises data associated with the PAwR train.

18. The method of claim 15, wherein the message is transmitted on a legacy channel.

19. The method of claim 15, wherein the message is an extended advertising packet.

20. The method of claim 15, wherein the initiation request message is a camping initiation message, and wherein the initiation response message is a camping confirmation message.

21. The method of claim 15, wherein the initiation request message comprises wireless communication device identification information and cryptographic information.

22. The method of claim 15, wherein the plurality of available channel subframes are coded within a bit mask included in the message.

23. The method of claim 15, wherein establishing the synchronized connection comprises establishing a generate attribute profile (GATT) connection.

24. The method of claim 15, further comprising receiving, by the network device from a network entity, a command to start onboarding at least one of the plurality of wireless communication devices.

25. The method of claim 24, wherein the network entity is a management entity (ME).

26. The method of claim 15, further comprising receiving, by the network device from a network entity, a command to stop onboarding the one or more wireless communication devices.

27. The method of claim 15, wherein network device is an access point (AP).

28. The method of claim 15, wherein each wireless communication device of the plurality of wireless communication devices is a Bluetooth low energy (BLE) device.
